(19) United States
(12) Patent Application Publication
(10) Pub. No.: US 2025/0292270 A1
(43) Pub. Date: Sep. 18, 2025

(54) SYSTEM FOR ANALYZING SALE VOLUME OF E-COMMERCE COMMODITY

(71) Applicant: SHENZHEN MEIYUNJI NETWORK TECHNOLOGY CO., LTD, ShenZhen (CN)

(72) Inventors: Zhichao WANG, ShenZhen (CN); Di Liu, ShenZhen (CN); Xihao Huang, ShenZhen (CN)

(73) Assignee: SHENZHEN MEIYUNJI NETWORK TECHNOLOGY CO., LTD, ShenZhen (CN)

(21) Appl. No.: 19/077,535

(22) Filed: Mar. 12, 2025

(30) Foreign Application Priority Data
Mar. 14, 2024 (CN) 202410294407.3

(51) Int. Cl. G06Q 30/0202; G06Q 30/0201; G06Q 30/0242; G06Q 30/0282

(52) U.S. Cl. CPC G06Q 30/0202; G06Q 30/0206; G06Q 30/0246; G06Q 30/0282

(57) ABSTRACT

A system for analyzing a sale volume of an e-commerce commodity. The system includes a data analysis module. The data analysis module includes a market analysis module, a traffic analysis module and a price analysis module. The market analysis module includes a traffic word module and a competitive commodity module. The traffic word module is configured to monitor a rank change of an e-commerce commodity traffic word, and the competitive commodity module is configured to monitor a sale volume change trend of a competitive commodity. The traffic analysis module is configured to analyze a traffic change of the e-commerce commodity. The price analysis module is configured to analyze a price change trend of the e-commerce commodity and a price change trend of the competitive commodity.

### TECHNICAL FIELD

The present application relates to the technical field of computers, and in particular to a system and a method for analyzing a sale volume of an e-commerce commodity, a method for warning the sale volume of the e-commerce commodity, and systems corresponding to each method.

### BACKGROUND

With the rise of global e-commerce, international retail trade has developed rapidly, and a large number of domestic small and medium-sized e-commerce sellers have expanded their retail business to foreign markets, and sold many domestic commodities to foreign markets through overseas e-commerce platforms. With the development of cross-border business, the e-commerce enterprise resource planning (ERP) system developed based on ERP software have gradually developed. e-commerce ERP system can be deeply connected with e-commerce platforms to help domestic small and medium-sized e-commerce sellers manage their overseas stores in a unified manner, which can avoid the obstacles caused by language differences, and enable one operator to manage hundreds of e-commerce stores at the same time, thereby greatly improving the efficiency of store operations.

E-commerce ERP system accesses and controls stores on e-commerce platforms through established rules, and processes dynamic data in all links during store operations. There is a complex data management. In addition, the operation convenience requirements of various types of users should be met. Therefore, the various functional modules of existing commercialized e-commerce ERP system are still in the stage that the functions are gradually updated and improved. The functional algorithms and rules formulated by various software companies when software companies develops their own e-commerce ERP systems are different. Each functional module will continue to develop new versions with the changes of user need, to be compatible with more usage scenarios.

During actual e-commerce activities, the commodity sale volume will fluctuate beyond the normal range, which is usually called abnormal fluctuations in the commodity sale volume. At present, the method for analyzing abnormal fluctuations of the sale volume in the market is mainly performed based on traffic and conversion rate of commodity advertisements, and then the reason for abnormal fluctuations in the sale volume of the e-commerce commodity can be finally concluded. However, this method for analyzing the sale volume can usually be applied to the commodity with more advertisement deliveries, and it is difficult to apply this method to commodities with less or even no advertisement deliveries.

In addition, when there is abnormal fluctuation in the commodity sale volume, users cannot promptly know the reasons for abnormal fluctuations, and users cannot effectively adjust the operation strategy, so that it is difficult to improve the sale volume trend of commodities.

Other technical issues related to present application will be further described later. The above contents are only configured to assist in understanding the technical solutions of present application, and do not mean that all above contents fall within the related art.

### SUMMARY

The main purpose of the present application is to provide a method and a system for analyzing a sale volume of an e-commerce commodity, which can not only analyze the reasons for fluctuations in the sale volume of various commodities, but also can be applied to commodities with advertisement deliveries and commodities without advertisement deliveries, thereby improving accuracy of analysis results. In addition, the present application further provides a method for warning the sale volume of the e-commerce commodity, which generates operation warning information corresponding to fluctuations in the commodity sale volume, so that users can promptly know the factors causing commodity sale volume fluctuations and take effective operation adjustment strategies.

To achieve the above purpose, the present application proposes a method and a system for analyzing a sale volume of an e-commerce commodity. The method includes following steps.

Step S1, obtaining sale volume data of a preset commodity on the e-commerce platform.

Step S2, in response to detecting that the sale volume fluctuation of the preset commodity exceeds the preset threshold, obtaining preset marketing data, traffic data and price data on the e-commerce platform where the preset commodity is displayed. The preset marketing data represents the market demand of the preset commodity on the e-commerce platform, and the preset marketing data includes commodity traffic word data and sale volume data of the competitive commodity. The commodity traffic word is a word representing the main attribute of the preset commodity and is configured to search for the preset commodity on the e-commerce platform. The traffic data represents the exposure degree of the preset commodity on the e-commerce platform.

Step S3.1, analyzing the preset marketing data to obtain the commodity category demand change and competitive commodity influence corresponding to the preset commodity, and determining the market demand change influence based on the commodity category demand change and competitive commodity influence. The competitive commodity is a commodity belonging to the commodity category corresponding to the preset commodity. Step S3.2, analyzing the traffic data to obtain the exposure change influence of the preset commodity. Step S3.3, analyzing the price data to obtain the price change influence of the preset commodity.

Step S4, determining the target factor that causes the sale volume fluctuation of the preset commodity based on the market demand change influence, the exposure change influence and the price change influence of the preset commodity.

Other features and technical effects of the present application are described in the latter part of the specification.

The technical solutions for the technical problem of the present application are described in the following.

The applicant found that the search ranks of the commodity traffic word on the e-commerce platform can reflect the market demand for the commodity type. If the search rank data of the commodity traffic word is collected and analyzed, it is possible to verify the sale volume trend of the same type of commodities from a sideways perspective. For example, when the search rank of one traffic word of a commodity drops sharply, the reason for the obvious change in its rank is likely to be that the overall market demand for such commodities has decreased. Therefore, a market analysis module is set at the data analysis module of the system for analyzing the sale volume of the e-commerce commodity. The market analysis module includes a traffic word module for monitoring the rank change of the e-commerce commodity traffic word.

In addition, the applicant further found that the sales of competitive commoditys may further have a significant impact on the sales of the commodity. For example, if a commodity is more popular in the market and a large number of users buy the commodity, the sales of other commodities of the same type will be affected. In this way, the sale volume information of competitive commodities is obtained and analyzed, so the reasons for the fluctuations in the sale volume of the commodities in this store can be verified to a certain extent, and the analysis results based on the traffic word search rank can be supplemented and verified to improve the overall accuracy of the commodity sale volume analysis. Therefore, a competitive commodity module is further set at the market analysis module to monitor the sale volume change trend of the competitive commodity.

On this basis, since the exposure of the commodity is an important factor affecting the sale of the commodity, a traffic analysis module is further set at the data analysis module. The traffic analysis module includes an advertising traffic module and a natural traffic module, which are used to monitor the changes in the exposure degree of the commodity.

In addition, the applicant further found that the price change of the commodity can reflect the sale volume change trend of the commodity. If the commodity price information is processed and the noise is removed, the price change trend and the sale volume change trend of the commodity in the same period are analyzed, then the reasons for the fluctuations in the sale volume of the commodity can further be verified to a certain extent. Therefore, a price analysis module is further set at the data analysis module to monitor the price changes of the commodity and the competitive commodity.

In summary, if the above external market factors, exposure change influence, and price change influence are comprehensively analyzed, the accuracy of analyzing abnormal fluctuations in the sale volume of the commodity can be greatly improved. Moreover, due to the introduction of evaluation factors other than advertising traffic factor, such as external market factors and exposure change influence, the reasons for abnormal fluctuations in the sale volume can be accurately analyzed for commodities with less or no advertisement.

The analysis order of commodity sales in this application further reflects the importance difference of the above factors, that is, the importance of external market factors, exposure change influence, and price change influence decreases from high to low. In addition, the information required for sale analysis in this application is not difficult to obtain, such as commodity traffic word search rank data, traffic data, price data, and other related data information can be directly obtained on the e-commerce platform, which reduces the difficulty of performing sale analysis and improves the efficiency of sales analysis.

In this way, the method for analyzing a sale volume of an e-commerce commodity proposed in the present application can not only simultaneously perform effective sale analysis on advertising commodities and non-advertising commodities, find out the influence factor of sales changes, and improve the application scope and analysis efficiency of the method, but also can improve the accuracy of commodity sale analysis results and reduce the difficulty of performing sale analysis, thereby ultimately improving e-commerce operation efficiency and corporate profits.

Moreover, the present application further provides a method for warning the sale volume of the e-commerce commodity, which mainly includes following steps P1 to P4.

Step P1, obtaining preset marketing data, traffic data and price data of the preset commodity on the e-commerce platform.

Step P2, analyzing the preset marketing data to determine the market demand change influence of the preset commodity, the market demand change influence including commodity category demand change and competitive commodity influence; analyzing the traffic data to obtain the exposure change influence of the preset commodity; and analyzing the price data to obtain the price change influence of the preset commodity.

Step P3, determining the target factor that causes sale volume fluctuation of the preset commodity based on the market demand change influence, the exposure change influence and the price change influence of the preset commodity.

Step P4, generating operation warning information based on the type of the target factor. The operation warning information includes adjusting the commodity stock strategy or adjusting the commodity advertisement delivery strategy.

The method for warning the sale volume of the e-commerce commodity proposed in the present application generates corresponding operation warning information according to the analysis results after analyzing the reason for commodity sale volume fluctuations, so that users can timely learn the reason for commodity sale volume fluctuations through the operation warning information, and take corresponding effective operation adjustment strategies according to the operation warning information, thereby improving the commodity sale trend.

Furthermore, the present application also provides a system for analyzing the sales volume of the e-commerce commodity, which is used to analyze the reason for sale volume fluctuations of both advertising commodities and non-advertising commodities. The system for analyzing the sales volume of the e-commerce commodity includes a data analysis module. The data analysis module includes a market analysis module, a traffic analysis module and a price analysis module. The market analysis module includes a traffic word module and a competitive commodity module. The traffic word module is used to monitor the rank change of the e-commerce commodity traffic word. The competitive commodity module is used to monitor the sale change trend of the competitive commodity. The e-commerce commodity is a commodity to be analyzed, and the competitive product is a commodity belonging to a commodity category corresponding to the commodity to be analyzed. The traffic analysis module is used to analyze the traffic change of the e-commerce commodity, and the price analysis module is used to analyze the price change trend of the e-commerce commodity and the competitive product. The data analysis module is used to analyze the sales change of the e-commerce commodity based on multiple influence factors. The influence factor includes the traffic word rank data of the e-commerce commodity, the sale volume data of the competitive commodity, the price data of the e-commerce commodity and the price data of the competitive commodity. The influence factor also includes the number of negative reviews at the homepage of the e-commerce commodity, the number of negative reviews at the Review page, and the Rating score.

The present application also provides a system, which is an e-commerce ERP system or an e-commerce platform system, and the system can execute the operation instructions of the method of the present application.

The present application also provides a server, which includes a memory and a processor. The system in the present application is stored in the memory, and the processor can execute the operation instructions of the method of the present application.

The present application also provides a computer device, which includes a memory and a processor. The system of the present application is stored in the memory, and the processor can execute the operation instructions of the method of the present application.

Referring to FIG. 1, the e-commerce ERP system of the present application includes one or more functional modules, such as the commodity module, the sale module, the procurement module, the logistics module, the warehouse module, the financial module, the advertisement module, the customer service module, the tool module, the authority management module, the data analysis module, and the like. The functional modules can be integrated with each other, or exist independently, or one functional module can be a submodule of another functional module. Users of the ERP system of the present application can also be called store managers, sellers, operators, operational staffs, and the like, and their identities are not strictly limited unless otherwise stated.

The meaning and description of terms in the present application which relate to the e-commerce field are illustrated in the following (the letters of English words in the present application are not case-sensitive).
(1) listing: product details page
(2) PV: page views
(3) Review: product review
(4) Rating: product rank score

### BRIEF DESCRIPTION OF THE DRAWINGS

The accompanying drawings are used to provide further understanding of the present application and do not constitute a limitation to the present application. Contents in the accompanying drawings may show real data of embodiments and shall fall within the scope of the present application.

FIG. 1 is a schematic diagram of functional modules in the e-commerce ERP system according to an embodiment of the present application.

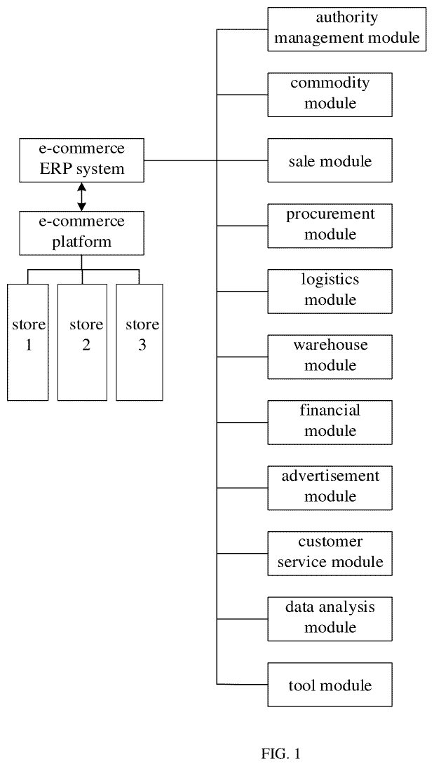

FIG. 2 is a flowchart of the method for analyzing a sale volume of an e-commerce commodity according to an embodiment of the present application.

FIG. 3 is a schematic structural diagram of a data analysis module according to an embodiment of the present application.

FIG. 4 is a schematic diagram of an application principle according to an embodiment of the present application.

FIG. 5 is a flowchart of the method for warning the sale volume of the e-commerce commodity according to an embodiment of the present application.

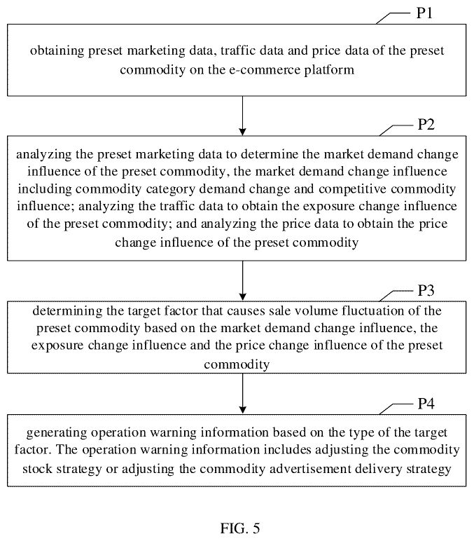

### DETAILED DESCRIPTION OF THE EMBODIMENTS

In order to make the purpose, technical solution and advantages of the present application clearer, the present application is further described in detail through specific implementation methods combined with the accompanying drawings. It should be understood that the specific embodiments described here are only used to explain the present application and are not configured to limit the present application.

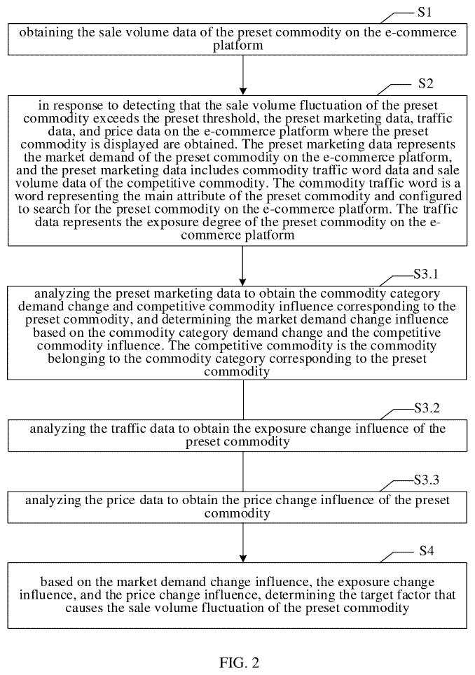

FIG. 2 shows a flowchart of the method for analyzing the sale volume of the e-commerce commodity according to an embodiment of the present application. The method for analyzing the sale volume of the e-commerce commodity mainly includes following steps S1 to S4.

Step S1, obtaining sale volume data of a preset commodity on the e-commerce platform.

Step S2, in response to detecting that the sale volume fluctuation of the preset commodity exceeds the preset threshold, obtaining preset marketing data, traffic data and price data on the e-commerce platform where the preset commodity is displayed. The preset marketing data represents the market demand of the preset commodity on the e-commerce platform, and the preset marketing data includes commodity traffic word data and sale volume data of the competitive commodity. The commodity traffic word is a word representing the main attribute of the preset commodity and is configured to search for the preset commodity on the e-commerce platform. The traffic data represents the exposure degree of the preset commodity on the e-commerce platform.

Step S3.1, analyzing the preset marketing data to obtain the commodity category demand change and competitive commodity influence corresponding to the preset commodity, and determining the market demand change influence based on the commodity category demand change and competitive commodity influence. The competitive commodity is a commodity belonging to the commodity category corresponding to the preset commodity. Step S3.2, analyzing the traffic data to obtain the exposure change influence of the preset commodity. Step S3.3, analyzing the price data to obtain the price change influence of the preset commodity.

Step S4, determining the target factor that causes the sale volume fluctuation of the preset commodity based on the market demand change influence, the exposure change influence and the price change influence of the preset commodity.

The present application proposes a method for analyzing the sale volume of the e-commerce commodity. In response to detecting that the sale volume fluctuation of the preset commodity exceeds a preset threshold, it is determined that there is an abnormal fluctuation in the sale volume of the preset commodity. Then the preset marketing data, traffic data and price data on the e-commerce platform where the preset is are displayed will be obtained. The preset marketing data represents the market demand for preset commodities on the e-commerce platform, which may include commodity category demand change and competitive commodity influence. The preset marketing data is used for analyzing external market factors that affect commodity sale volume fluctuations. The traffic data represents the exposure degree of preset commodities on the e-commerce platform, which is used for analyzing advertisement operation factors that affect commodity sale volume fluctuations. The above preset marketing data is analyzed to obtain the commodity category demand change and competitive commodity influence of the preset commodity. That is, by analyzing whether the user demand for the commodity category corresponding to the preset commodity is reduced, or by analyzing whether the competitive commodity has gained an advantage and affected the sale volume of the preset commodity, the market demand change influence can be determined. Then, for advertisement operation, the traffic data is analyzed to obtain the exposure change influence of the preset commodity. For the sale strategy, the price data is analyzed to obtain the price change influence of the preset commodity. Based on the market demand change influence, exposure change influence and price change influence, the target factor that causes the sale volume fluctuation of the preset commodity is determined, so that users can improve the e-commerce operation strategy by improving the target factor.

In this way, the method for analyzing the sale volume of the e-commerce commodity proposed in the present application can simultaneously perform effective analysis on advertisement commodities and non-advertisement commodities, and find out the influence factor for sale volume changes, thereby improving the application scope and analysis efficiency of the method, and improving the result accuracy for analyzing the sale volume of the commodity. In addition, the difficulty of performing sale volume analysis can be reduced, thereby ultimately improving e-commerce operation efficiency and corporate profits.

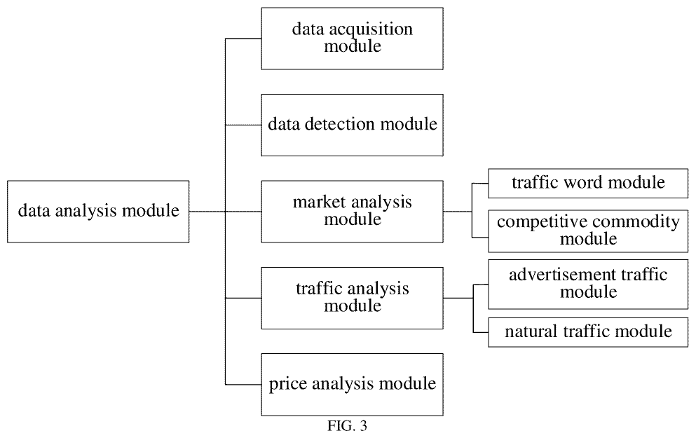

FIG. 3 shows a schematic structural diagram of a data analysis module according to an embodiment of the present application. The data analysis module includes a data acquisition module, a data detection module, a market analysis module, a traffic analysis module, and a price analysis module. In an embodiment, the data acquisition module is configured to obtain the data information required for performing commodity sale volume analysis on the e-commerce platform. The data detection module is configured to detect whether the commodity sale volume has fluctuated abnormally. The market analysis module includes a traffic word module for analyzing the commodity category demand and a competitive commodity module for analyzing the competitive commodity influence. The traffic analysis module includes an advertisement traffic module for analyzing the advertisement traffic change influence and a natural traffic module for analyzing natural traffic changes. The price analysis module is configured to analyze the price trend change influence of commodities and competitive commodities.

The following is a detailed description of each step in the method for analyzing the sale volume of the e-commerce commodity.

Step S1, obtaining the sale volume data of the preset commodity on the e-commerce platform.

In an embodiment, the e-commerce ERP system obtains the sale volume data of the commodity on the e-commerce platform and monitors the sale volume fluctuation of the commodity.

Step S2, in response to detecting that the sale volume fluctuation of the preset commodity exceeds the preset threshold, the preset marketing data and traffic data on the e-commerce platform where the preset commodity is displayed are obtained. The preset marketing data represents the market demand of the preset commodity on the e-commerce platform, and the preset marketing data includes commodity traffic word data and sale volume data of the competitive commodity. The commodity traffic word is a word representing the main attribute of the preset commodity and configured to search for the preset commodity on the e-commerce platform. The traffic data represents the exposure degree of the preset commodity on the e-commerce platform.

In an embodiment, in response to detecting that the sale volume fluctuation of the preset commodity exceeds the preset threshold, it is determined that there are abnormal fluctuations in the sale volume of the preset commodity, then the preset marketing data and traffic data on the e-commerce platform where the preset commodity is displayed are obtained. The above preset threshold can be set according to actual needs and is not specifically limited here. The preset marketing data represents the market demand of the preset commodity on the e-commerce platform, and is used for analyzing the external market factors affecting fluctuation in the sale volume of the commodity. The preset marketing data may include, search rank data of the commodity traffic word, commodity repurchase rate, and the commodity coupon collection quantity. The traffic data represents the exposure degree of the preset commodity on the e-commerce platform, and is used for analyzing the advertisement operation factors affecting fluctuation in the sale volume of the commodity. The traffic data may include the commodity page click rate, the commodity exposure rate, the advertisement conversion rate, and the like.

Step S3.1, analyzing the preset marketing data to obtain the commodity category demand change and competitive commodity influence corresponding to the preset commodity, and determining the market demand change influence based on the commodity category demand change and the competitive commodity influence. The competitive commodity is the commodity belonging to the commodity category corresponding to the preset commodity.

In an embodiment, among the external market factors, commodity category demand change and competitive commodity influence can affect the sale volume of the preset commodity. commodity category demand change refers to the reduction of the users demand in the market for the commodity category corresponding to the preset commodity, so the sale volume of the preset commodity will also be affected. Competitive commodity influence indicates whether other commodities with the same attributes as the preset commodity in the commodity category corresponding to the preset commodity have better competitive advantages, resulting in the situation that when the demand for the commodity category remains unchanged, the user demand for the preset commodity is reduced since the competitive commodity is more popular with users.

Step S3.2, analyzing the traffic data to obtain the exposure change influence of the preset commodity.

In an embodiment, from the perspective of internal commodity operation, among the advertisement operation factors, analyzing the traffic data that represents the exposure degree of the commodity can also determine the reasons for fluctuation in the commodity sale volume. In an embodiment, advertisement delivery and natural traffic distribution can be selected as the entry points. Advertisement delivery strategy mainly refers to the influence of different advertisement delivery strategies and links of advertisement delivery strategy on the commodity sale volume, while natural traffic is related to the page display element of the commodity, such as the number of negative reviews at the review homepage, the number of negative reviews at the page, the rank score, commodity reviews, and the like. The natural traffic may also be related to changes in competitive commodities, including changes in competitive commodity titles, changes in main pictures, and adjustments to Bullet Points. In this way, analyzing the traffic data can determine the exposure traffic changes and display effects of the preset commodity on the e-commerce platform, to determine the target factor that causes the sale volume fluctuation of the preset commodity.

Step S3.3, analyzing the price data to obtain the price change influence of the preset commodity.

In an embodiment, price is also an important factor that can affect the commodity sale volume in e-commerce activities. By analyzing the price data of the preset commodity, it can be determined whether the sale volume fluctuation of the preset commodity is caused by the lower price of the competitive commodity, or whether the sale volume fluctuation of the preset commodity is caused by the special preferential rules adopted by the competitive commodity and the competitive commodity gains a competitive advantage and causes sale volume fluctuation of the preset commodity.

Step S4, based on the market demand change influence, the exposure change influence, and the price change influence, determining the target factor that causes the sale volume fluctuation of the preset commodity.

In an embodiment, from three dimensions, namely the external market factor, the advertisement operation factor, and the sale volume strategy, the preset marketing data, traffic data, and price data are analyzed respectively. Then according to the relationship between the market demand change influence, exposure change influence, and price change influence corresponding to the preset commodity and the sale volume fluctuation, the target factor that causes the sale volume fluctuation of the preset commodity is determined, which can be used for user to refer to and adjust the e-commerce operation strategy.

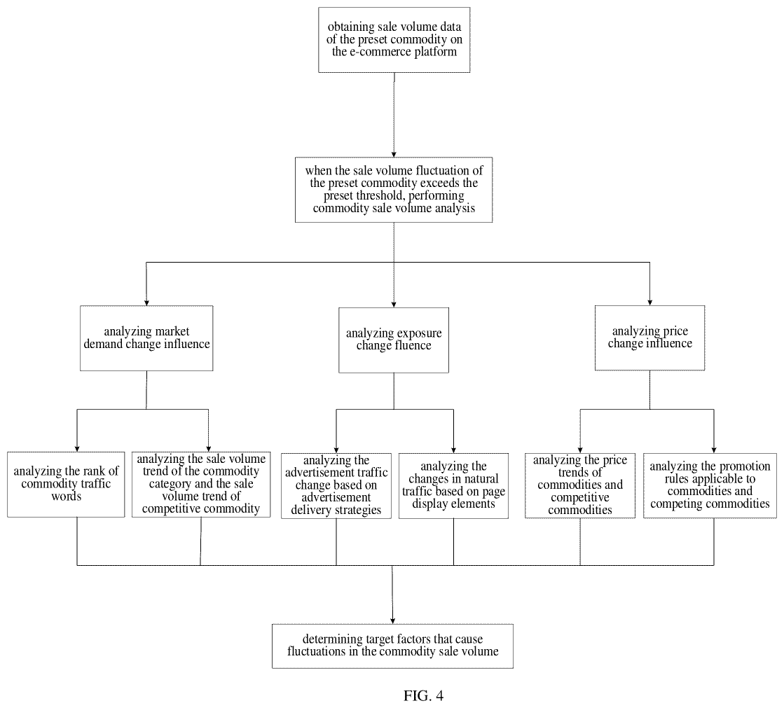

Further, as shown in FIG. 4, in an embodiment, the preset marketing data includes commodity traffic words, which represent main attributes of the preset commodity and are configured to search for the preset commodity on the e-commerce platform. The above step S3.1, analyzing the preset marketing data to obtain the commodity category demand change corresponding to the preset commodity, includes following steps S3.11 and S3.12.

Step S3.11, determining search rank data of the commodity traffic word on the e-commerce platform.

Step S3.12, analyzing search rank data of the commodity traffic word to obtain the commodity category demand change corresponding to the preset commodity.

In an embodiment, on the e-commerce platform, users can filter commodities that meet specific attributes by searching for some commodity traffic words, and the e-commerce platform, such as Amazon, will publish the search rank data of commodity traffic words. In this embodiment, by analyzing the search rank data of commodity traffic words, it is possible to determine changes in the market demand. For example, if the commodity traffic word of the preset commodity drops significantly in the search rank, it means that the users demand for this type of commodities in the market has dropped, that is, the demand for the commodity category to which the preset commodity belongs has dropped.

Further, in an embodiment, the preset marketing data further includes category sale volume data of the preset category to which the preset commodity belongs, and sale volume data of the competitive commodity corresponding to the preset category. The step S3.1, analyzing the preset marketing data to obtain the competitive commodity influence corresponding to the preset commodity, includes following steps S3.13 and S3.14.

Step S3.13, comparing the category sale volume data, the sale volume data of the competitive commodity with the sale volume of the preset commodity in terms of the change degree and the change trend to obtain a first comparison result.

Step S3.14, determining the competitive commodity influence corresponding to the preset commodity according to the first comparison result.

In an embodiment, the sale volume data of the category to which the preset commodity belongs, the sale volume data of the competitive commodity, and the sale volume data of the preset commodity are compared. If the sale volume change trends of the competitive commodity and the preset commodity have changed significantly under situation that the sale volume change trend of the commodity category is basically stable, it can be determined that the competitive commodity exerts an influence on the sale volume fluctuation of the preset commodity.

For example, assuming that the sale volume change trend of the commodity category is stable, the sale volume of the competitive commodity increases while the sale volume of the preset commodity decreases, it means that the competitive commodity has gained a competitive advantage and has a major influence on the sale volume fluctuation of the preset commodity. Similarly, if both the sale volumes of the competitive commodity and the preset commodity decrease, it means that other commodities belonging to the commodity category have gained a competitive advantage and have a major influence on the sale volume fluctuation of the preset commodity.

Further, in an embodiment, the traffic data includes commodity advertisement sale volume, and step S3.2 includes following steps S3.21 to S3.24.

Step S3.21, obtaining the commodity advertisement sale volume corresponding to each advertisement delivery strategy applied to the preset commodity on the e-commerce platform.

Step S3.22, determining the contribution ratio of the commodity advertisement sale volume to the sale volume fluctuation of the preset commodity, and determining the advertisement delivery strategy whose contribution ratio reaches the preset ratio as the target delivery strategy.

Step S3.23, determining the advertisement delivery factor that causes the advertisement traffic change based on the target delivery strategy.

Step S3.24, determining the exposure change influence based on the advertisement delivery factor.

In an embodiment, the advertisement delivery strategy includes delivery traffic word, automatic delivery, commodity delivery and other strategy types. The delivery traffic word means setting specific traffic words for preset commodities. In response to that users search for the specific traffic words on the e-commerce platform, the search results will show the preset commodities. Automatic delivery means that the e-commerce platform or the e-commerce ERP system automatically sets traffic words for preset commodities based on the big data analysis results. The commodity delivery means that the preset commodity is bound to a target commodity, and in response to that users search for the target commodity on the e-commerce platform, the search results will show the preset commodities that have a binding relationship with the target commodity.

It can be understood that in actual e-commerce activities, there may be a plurality of advertisement delivery strategies applied to a certain commodity. After all, each advertisement delivery strategy has different resource investment and different influences on commodity sales. In this embodiment, the commodity advertisement sale volume corresponding to each advertisement delivery strategy applied to the preset commodity on the e-commerce platform is obtained, and then the contribution ratio of the commodity advertisement sale volume to the sale volume fluctuation of the preset commodity is determined. If the contribution ratio of the commodity advertisement sale volume is large and the contribution ratio of the advertisement delivery strategy to the commodity sale volume is negative, the advertisement delivery strategy is determined to be the target delivery strategy that has a major negative influence on the commodity sale volume fluctuation, so as to further analyze the target delivery strategy and subsequently generate e-commerce operation suggestions for adjusting the target delivery strategy.

Further, based on the above embodiment, the above step S3.23 includes following steps S3.231 and S3.232.

Step S3.231, obtaining each advertisement sale volume contribution rate corresponding to the exposure link, the click link and the conversion link of the target delivery strategy.

Step S3.232, determining the advertisement delivery factor that causes the exposure change of the preset commodity according to the advertisement sale volume contribution rate.

In an embodiment, obtaining each advertisement sale volume contribution rate corresponding to the exposure link, the click link and the conversion link of the target delivery strategy on the e-commerce platform, and the advertisement sale volume contribution rate represents the influence direction and the influence degree of the target delivery strategy on the commodity sale volume in the exposure link, the click link and the conversion link. For example, if advertisement sale volume contribution rates of the exposure link, the click link and the conversion link are 3.22%, 5.46%, and −4.35%, respectively, it means that the target delivery strategy has a big problem in the conversion link. The user should optimize the conversion link of the target delivery strategy.

For the contribution rate calculation of each link in the advertisement delivery strategy, following formulas will be illustrated.

For the additive decomposition type:

$$Y = X 1 + X 2$$

Given,

The target fluctuation:

$$△ Y \% = \frac{{Y}^{1} - {Y}^{0}}{{Y}^{0}}$$

The calculation formula of the month-on-month fluctuation factor contribution rate Ci of indicator Y is:

$$△ Y \% = {C}_{{x}_{i}} = \frac{{X}_{i}^{1} - {X}_{i}^{0}}{{Y}^{0}} = \frac{{△X}_{i}}{{Y}^{0}}$$

It can be understood that the above additive decomposition type formula is applicable to the contribution rate calculation in response to that parallel indicators are added.

For example, total traffic=advertisement traffic+natural traffic. Y is the total traffic. X1 is the advertisement traffic. X2 is the natural traffic. Y¹ is the total traffic of the current period. Y⁰ is the total traffic of the previous period. ΔY % is the month-on-month value of the total traffic. If it is used to calculate the contribution of advertisement traffic and natural traffic to the change of total traffic, the month-on-month fluctuation of total traffic=advertisement traffic contribution+natural traffic contribution. Cₓᵢ is the sum of contribution rates. Xᵢ¹ is the current period data of advertisement traffic or natural traffic. Xᵢ⁰ is the previous period data of advertisement traffic or natural traffic, and the subscript i represents advertisement traffic or natural traffic.

It can be understood that the dimensional decomposition of absolute value indicators is additive decomposition. The year-on-year change or month-on-month change of absolute quantity indicators can be the weighted sum of changes of each sub-indicator, which includes that the sum of the page view (PV) of the commodity details page (listing) on the Amazon platform is equal to the sum of the PV on each channel, then the contribution rate of the change of the total PV is equal to the change of each channel divided by the total PV for the previous month.

| | | | Month- | Monthly sale | |
|---|---|---|---|---|---|
| | PV of | PV of | on-month | volume | Contribution |
| Channel | May | June | PV | difference | rate |
| advertisement | 600 | 500 | −16.67% | −100 | −10.00% |
| traffic | | | | | |
| natural traffic | 400 | 555 | 38.75% | 155 | 15.50% |
| sum | 1000 | 1055 | 5.50% | — | — |

In view of data above, it is found that the sum PV has increased, but the increase range is not large, which is mainly affected by advertisement. The advertisement PV has decreased by −16.67% month-on-month, and the contribution rate is −10%, which has reduced the overall traffic growth.

For ratio decomposition type:

Given,

$$Y = \frac{S}{P} = \frac{\sum {s}_{{X}_{i}}}{\sum {p}_{{X}_{i}}} , {P}_{i} = \frac{{p}_{{X}_{i}}}{\sum {p}_{{X}_{i}}} , {S}_{i} = \frac{{s}_{{X}_{i}}}{\sum {s}_{{X}_{i}}} , {Y}_{i} = \frac{{p}_{{X}_{i}}}{{s}_{{X}_{i}}}$$

Contribution of indicator change of sub-items:

$${A}_{{X}_{i}} = ( {Y}_{i}^{1} - {Y}_{i}^{0} ) * {P}_{i}^{0}$$

Contribution of structural proportion change of sub-items:

$${B}_{{X}_{i}} = ( {P}_{i}^{1} - {P}_{i}^{0} ) * ( {Y}_{i}^{1} - {Y}^{0} )$$

$$Target fluctuation :$$

$$△ Y \% = \frac{{Y}^{1} - {Y}^{0}}{{Y}^{0}}$$

The calculation formula of the month-on-month fluctuation factor contribution rate Cₓᵢ of indicator Y is:

$${C}_{{X}_{i}} = \frac{L ( {Y}^{1} , {Y}^{0} ) * ln ( \frac{{X}_{i}^{1}}{{X}_{i}^{0}} )}{{Y}^{0}}$$

, where X1 is the data of the current period, and X0 is the data of the previous period.

L(Y⁰, Y⁰) is the average logarithmic weight, and there is a formula:

$$L ( {Y}^{1} , {Y}^{0} ) = \frac{{Y}^{1} - {Y}^{0}}{ln ( {Y}^{1} ) - ln ( {Y}^{0} )} = \frac{△ Y}{ln ( {Y}^{1} ) - ln ( {Y}^{0} )}$$

It can be understood that the above ratio decomposition type formula is applicable to the contribution rate calculation when the indicators are compared, that is, the attribution of ratio indicators, such as the click rate and the conversion rate.

For example, commodity click rate=click volume/exposure volume. Y is the commodity click rate. S is click volume. P is exposure volume. Sₓᵢ represents click volume. Click volume=advertisement click volume+natural click volume. For Sₓᵢ, subscript i represents advertisement click volume or natural click volume. Pₓᵢ represents exposure volume. Exposure volume=advertisement exposure volume+natural exposure volume. For Pₓᵢ, subscript i represents advertisement exposure volume or natural exposure volume. Pi represents the proportion of advertisement exposure volume to total exposure volume. Yᵢ represents the advertisement click rate or the natural click rate. Y⁰ represents the total click rate of the previous period. Y¹ represents the total click rate of the current period. Yᵢ¹ represents the advertisement click rate in the current period. Yᵢ⁰ represents the advertisement click rate in the previous period. Pᵢ¹ represents the advertisement click rate in the previous period, and Pᵢ⁰ represents the advertisement click rate in the current period.

For multiplication decomposition type:

Given

$$Y = \prod {X}_{i}$$

Target fluctuation:

$$△ Y \% = \frac{{Y}^{1} - {Y}^{0}}{{Y}^{0}}$$

The calculation formula of the month-on-month fluctuation factor contribution rate Ci of indicator Y is:

$${C}_{{X}_{i}} = \frac{L ( {Y}^{1} , {Y}^{0} ) * ln ( \frac{{X}_{i}^{1}}{{X}_{i}^{0}} )}{{Y}^{0}} ,$$

where X¹ is the data of the current period, and X⁰ is the data of the previous period.

L(Y¹, Y⁰) is the average logarithmic weight, and there is a formula:

$$L ( {Y}^{1} , {Y}^{0} ) = \frac{{Y}^{1} - {Y}^{0}}{ln ( {Y}^{1} ) - ln ( {Y}^{0} )} = \frac{△ Y}{ln ( {Y}^{1} ) - ln ( {Y}^{0} )}$$

It can be understood that the above multiplication decomposition type formula is applicable to the calculation of the contribution influence of each sub-item to the whole when the absolute value indicators are multiplied.

For example,

$$Y = {\prod }_{i} {X}_{i}$$

sale volume=traffic*conversion rate. Y is sale volume. X₁ is traffic. X² is the conversion rate. Y⁰ represents the sale volume of the previous period, and Y¹ represents the sale volume of the current period.

Further, based on the above embodiment, the above step S3.24 includes following steps S3.241 to step S3.243.

Step S3.241, comparing the page display element of the preset commodity with the preset display standard to obtain a second comparison result.

Step S3.242, determining the natural traffic change influence according to the second comparison result.

Step S3.243, determining the exposure change influence according to the advertisement delivery factor and the natural traffic change influence.

In an embodiment, the exposure traffic allocation of the e-commerce platform for the commodity includes the exposure traffic brought by advertisement delivery and the natural traffic automatically allocated by the system. In this embodiment, the natural traffic is related to the page display element of the preset commodity. The page display element of the preset commodity will affect the display effect of the commodity display page, including the comment change of the commodity display page, the number of negative reviews at the comment homepage, the number of negative reviews at the Review page, the Rating commodity rank score, and the like. The above factors can be analyzed to determine the natural traffic change influence generated by the page display element of the preset commodity.

Further, based on the above embodiment, the above step S3.242 includes following steps S3.2421 and S3.2422.

Step S3.2421, comparing the page display element of the competitive commodity with the preset display standard to obtain a third comparison result.

Step S3.2422, determining the natural traffic change influence according to the second comparison result and the third comparison result.

In an embodiment, the change of the display element of the competitive commodity

at the commodity display page may cause the competitive commodity to obtain more exposure traffic, thereby reducing the exposure traffic of the preset commodity allocated by the system. In this embodiment, the page display element of the competitive commodity that will affect the natural traffic distribution includes the change of the competitive commodity title, the change of the main picture, and the adjustment of the Bullet Point. In this embodiment, it is analyzed that whether the better page display effect of the competitive commodity is caused by the change of the page display element of the competitive commodity, the natural traffic distribution obtained by the preset commodity is reduced, and the sale volume fluctuation of the preset commodity is ultimately caused.

Further, in an embodiment, step S3.3 includes following steps S3.31 and S3.32.

Step S3.31, comparing the price trends of the preset commodity with the price trends of the competitive commodity to obtain a fourth comparison result.

Step S3.32, determining the price change influence according to the comparison result.

In an embodiment, by comparing the price trends of the preset commodity with the price trends of the competitive commodity, it can be determined whether the competitive commodity has gained a competitive advantage due to its lower price, thereby causing the sale volume fluctuation of the preset commodity. The comparison process may include comparing the initial pricing of the preset commodity and the initial pricing of the competitive commodity, and may further include comparing the preferential activity rules of the preset commodity and the preferential activity rules of the competitive commodity.

Further, in an embodiment, after the above step S4, the method further includes following steps S5.1 and S5.2.

Step S5.1, sorting and displaying the target factor according to the priorities of the market demand change influence, the exposure change influence and the price change influence.

Step S5.2, generating corresponding operation suggestions based on the sorting and displaying results of the target factor.

In an embodiment, there are many ways to determine the priority. For example, the priority can be determined according to the change ranges of the market demand change influence, the exposure change influence and the price change influence. That is, assuming that the market demand changes greatly and the price changes less, the market demand change influence is set to the highest priority and the price change influence is set to the lowest priority. For another example, the priority can be set according to the user's needs. If the user believes that the exposure change influence needs to be considered and adjusted, the exposure change influence can be set to the highest priority.

After determining the priority, the display methods of the target factors corresponding to market demand change influence, exposure change influence, and price change influence are adjusted according to the priority. For example, assuming that the priority of market demand change influence is the highest, the target factor causing the market demand change influence, such as the decreased demand for this type of commodity in the market, will be displayed with bright colors and in a larger display area. It can be understood that the specific display method is not limited here. In this embodiment, adjusting the display method of the target factor according to the priority can make the display method of the target factor more consistent with the user's needs and improve the display effect of the target factor.

On this basis, after determining the display method of the target factor according to the priority, the corresponding operation suggestions are generated for user reference. For example, assuming that the market demand change influence has the highest priority, and the target factor is the decreased demand of users for this type of commodity in the market, then the generated operation suggestion is, adjusting the investment ratio of the current commodity, or even suggesting replacing other commodities for promotion and sales, and adding other auxiliary or secondary operation suggestions on this basis, such as adjusting the specific links of the target delivery strategy. That is, the main part of the operation suggestion corresponds to the target factor with a high priority. In this embodiment, the operation suggestion is generated according to the priority. Since the operation suggestion corresponds to the target factor with a high priority, it has higher feasibility and effectiveness for users to refer to.

In an embodiment, in response to that the preset marketing data is analyzed to determine that the commodity category demand change reaches a preset range, for example, the search rank of the commodity traffic word drops to a preset range, the analysis steps for the exposure change influence and the price change influence are no longer performed, and the corresponding operation suggestion, such as replacing the current commodity for sales and promotion, will be directly generated. Compared with other factors, market demand change influence has the greatest influence on commodity sale volume fluctuations and will determine the main operation strategy adopted by sellers for the commodity to a large extent. If the analysis step for market demand change influence shows that the overall demand for the commodity category in the market has dropped significantly, that is, consumers have a very low demand for this type of commodities, then it is difficult for sellers to adjust the operation strategy to restore the commodity sale volume to normal. Therefore, there is no need to analyze other factors that may cause commodity sale volume fluctuations, thereby saving system computing costs and improving the efficiency of commodity sale volume analysis.

In response to that the preset marketing data is analyzed to determine that the competitive commodity influence is the main factor causing the sale volume fluctuation of the preset commodity, that is, the sale volume trend of the competitive commodity is better than the sale volume trend of the preset commodity to a preset degree, the page display element and price data of the competitive commodity are directly analyzed. The factor with the greater influence between the page display element and the price data is configured as the target factor, which includes: in response to that the page display element of the competitive commodity is adjusted significantly, the page display element is determined as the target factor; or in response to that the price trend between the competitive commodity and the preset commodity is significantly different, the price factor is determined as the target factor, and corresponding operation suggestions are generated based on the target factor. Other analysis steps for exposure change influence are no longer performed.

It can be understood that in actual e-commerce activities, sellers usually need to manage a plurality of stores and a plurality of commodities. If the sale volume of each commodity in each store is analyzed, it is necessary to perform a comprehensive analysis on the external market factor, exposure change influence, and price change influence, which will lead to excessively high operation costs of the e-commerce ERP system and low sale volume analysis efficiency, thereby affecting the efficiency of e-commerce operation and management. In view of this, in this embodiment, it presets the analysis of market demand change influence as the highest priority, and determines whether it is necessary to perform the analysis steps on exposure change influence and price change influence based on the analysis results of the preset market demand change influence. The subsequent analysis steps for exposure change influence and price change influence can be omitted for commodities that are greatly affected by market demand change influence, thereby avoiding excessively high operation costs of the e-commerce ERP system due to numerous analysis steps, and improving the analysis efficiency. In this way, the management and operation efficiency of the e-commerce ERP system can be ultimately improved.

In an embodiment, the present application further provides a method for warning the sale volume of the e-commerce commodity, which mainly includes following steps P1 to P4.

Step P1, obtaining preset marketing data, traffic data and price data of the preset commodity on the e-commerce platform.

Step P2, analyzing the preset marketing data to determine the market demand change influence of the preset commodity, the market demand change influence including commodity category demand change and competitive commodity influence; analyzing the traffic data to obtain the exposure change influence of the preset commodity; and analyzing the price data to obtain the price change influence of the preset commodity.

Step P3, determining the target factor that causes sale volume fluctuation of the preset commodity based on the market demand change influence, the exposure change influence and the price change influence of the preset commodity.

Step P4, generating operation warning information based on the type of the target factor. The operation warning information includes adjusting the commodity stock strategy or adjusting the commodity advertisement delivery strategy.

In an embodiment, the preset marketing data, traffic data and price data of the preset commodity on the e-commerce platform are obtained, then the above data is analyzed to obtain the target factor that causes the sale volume fluctuation of the commodity. After that, operation warning information is generated based on the type of the target factor, so that the user can timely know the target factor that causes the sale volume fluctuation of the commodity according to the warning information, and the commodity stock strategy, such as increasing or decreasing the commodity stock quantity and adjusting the commodity advertisement delivery strategy, can be adjusted accordingly, thereby improving the sale volume trend of the commodity.

Further, in an embodiment, in response to determining the target factor as a market demand factor, the step P4 includes following steps P4.1 and P4.2.

Step P4.1, predicting the sale volume change range according to the search rank data in the search rank data.

Step P4.2, adjusting the commodity stock quantity and commodity replenishment cycle according to the sale volume change range.

In an embodiment, the search rank data of the commodity traffic words can reflect the market demand for similar commodities, and the market demand can have a deeper and more far-reaching influence on the commodity sale volume. Therefore, the future commodity sale volume trend can be predicted according to the search ranks of the commodity traffic words, and a commodity replacement strategy corresponding to the future commodity sale volume trend is generated, such as increasing or decreasing the commodity stock quantity, and extending or shortening the commodity replenishment cycle.

Further, in an embodiment, in response to determining the target factor as an advertisement delivery factor, the step P4 includes the following step P4.3.

Step P4.3, generating an advertisement adjustment strategy based on the target delivery strategy. The advertisement adjustment strategy includes adjusting the delivery type, delivery time and delivery location of the target delivery strategy.

In an embodiment, after determining the target delivery strategy that has the main negative influence on the commodity sale volume according to the advertisement sale volume contribution rate, generating an advertisement adjustment strategy corresponding to the target delivery strategy. The advertisement adjustment strategy includes adjusting the target delivery strategy from delivering traffic words to delivering commodity, changing the delivery time period and adjusting the advertisement delivery cost ratio in each region, to optimize the target delivery strategy, thereby improving the sale volume trend of the commodity.

Further, in an embodiment, in response to that the target factor is determined to be a price factor, the step P4 further includes following steps P4.4 and P4.5.

Step P4.4, obtaining the preferential activity information corresponding to the competitive commodity.

Step P4.5, generating a price adjustment strategy based on the price factor and the preferential activity information.

In an embodiment, after determining that the commodity price is the target factor that causes the sale volume fluctuation of the commodity, if the commodity price is too high, the commodity will lack a competitive advantage in the market. In this case, the preferential activity information applicable to the competitive commodity is obtained, and the corresponding price adjustment strategy is generated for the user's reference based on the preferential activity information and the relevant price data including the commodity price, the price of the competitive commodity, the average price of similar commodities, and the like.

Further, in an embodiment, in response to that the target factor is determined to be a competitive commodity factor, step P4 includes the following step P4.6.

Step P4.6, generating operation warning information based on the competitive commodity factor, and the operation warning information includes adjusting the delivery strategy of the commodity advertisement and the preferential activity rules applicable to the commodity.

In an embodiment, in response to determining that the sale volume of the competitive commodity have a significant influence on the commodity, the corresponding operation warning information is generated for the user's reference. The operation warning information includes reminding the user to adjust the commodity advertisement to increase the commodity exposure on the e-commerce platform, and adjusting the preferential activity rules applicable to the commodity, so that the commodity has a price advantage over the competitive commodity and similar commodities.

Further, in an embodiment, after step P4, the method further includes following steps P5.1 and P5.2.

Step P5.1, displaying the operation warning information on a preset interface.

In an embodiment, after the e-commerce ERP system generates the operation warning information, the operation warning information is displayed on a specific reminder interface, or the operation warning information is displayed on the operation/managing other function interface in a form of the pop-up window.

Step P5.2, sending the operation warning information to a preset terminal.

In an embodiment, after the e-commerce ERP system generates the operation warning information, the operation warning information is sent to a specific objective, such as a mobile phone, an email address, a specific account, and the like, to achieve the purpose of remote notification.

The above are only some embodiments of the present application, and do not limit the scope of the present application thereto. Under the concept of the present application, any equivalent structural transformation made according to the description and drawings of the present application, or direct/indirect applied in other related technical fields shall fall within the claimed scope of the present application.

What is claimed is:

1. A system for analyzing a sale volume of an e-commerce commodity, comprising: a data analysis module, and
the data analysis module comprises a market analysis module, a traffic analysis module, and a price analysis module;
the market analysis module comprises a traffic word module and a competitive commodity module, and the traffic word module is configured to monitor a rank change of an e-commerce commodity traffic word; the competitive commodity module is configured to monitor a sale volume change trend of a competitive commodity;
the e-commerce commodity is a commodity to be analyzed, and the competitive commodity is a commodity belonging to a commodity category corresponding to the commodity to be analyzed; the traffic analysis module is configured to analyze a traffic change of the e-commerce commodity, and the price analysis module is configured to analyze a price change trend of the e-commerce commodity and a price change trend of the competitive commodity;
the data analysis module is configured to analyze a sale volume change of the e-commerce commodity based on a plurality of influence factors, and the plurality of influence factors comprise traffic word rank data of the e-commerce commodity, sale volume data of the competitive commodity, price data of the e-commerce commodity, and price data of the competitive commodity; and
the plurality of influence factors further comprise a number of negative reviews at a homepage of the e-commerce commodity, a number of negative reviews at a Review page, and a Rating score.

2. The system for analyzing the sale volume of the e-commerce commodity according to claim 1, wherein the plurality of influence factors further comprise page display element change data of the competitive commodity, and the page display element change data comprises title change data for the competitive commodity, main picture change data and Bullet Point adjustment data.

3. The system for analyzing the sale volume of the e-commerce commodity according to claim 1, wherein:
the plurality of influence factors further comprise commodity category demand change data of the e-commerce commodity; and/or
the plurality of influence factors further comprise traffic exposure data of the e-commerce commodity; and/or
the traffic analysis module comprises an advertisement traffic module for analyzing an advertisement traffic change and a natural traffic module for analyzing a natural traffic change.

4. The system for analyzing the sale volume of the e-commerce commodity according to claim 1, wherein in response to analyzing the plurality of influence factors, the data analysis module is configured to reduce each importance weight of an external market factor, exposure change influence and price change influence from high to low importance weight.

5. The system for analyzing the sale volume of the e-commerce commodity according to claim 1, wherein in response to analyzing the sale volume change of the e-commerce commodity, the step of analyzing the sale volume change comprises:
step S1, obtaining sale volume data of the e-commerce commodity on an e-commerce platform;
step S2, obtaining preset marketing data, traffic data and price data on the e-commerce platform where the e-commerce commodity is displayed;
step S3.1, analyzing the preset marketing data to obtain a commodity category demand change and competitive commodity influence corresponding to the e-commerce commodity, and determining market demand change influence based on the commodity category demand change and the competitive commodity influence;
step S3.2, analyzing the traffic data to obtain exposure change influence of the e-commerce commodity;
step S3.3, analyzing the price data to obtain price change influence of the e-commerce commodity; and
step S4, determining a target factor causing sale volume fluctuation of the e-commerce commodity based on the market demand change influence, the exposure change influence and the price change influence of the e-commerce commodity.

6. The system for analyzing the sale volume of the e-commerce commodity according to claim 5, wherein step S3.1 comprises:
step S3.11, obtaining search rank data of the e-commerce commodity traffic word on the e-commerce platform; and
step S3.12, analyzing the search rank data of the e-commerce commodity traffic word to obtain the commodity category demand change corresponding to the e-commerce commodity.

7. The system for analyzing the sale volume of the e-commerce commodity according to claim 5, wherein step S3.2 comprises:
step S3.21, obtaining each commodity advertisement sale volume corresponding to each advertisement delivery strategy applied to the e-commerce commodity on the e-commerce platform;
step S3.22, determining a contribution ratio of the commodity advertisement sale volume to the sale volume fluctuation of the e-commerce commodity, and determining an advertisement delivery strategy with the contribution ratio reaching a preset ratio as a target delivery strategy;
step S3.23, determining an advertisement delivery factor causing an advertisement traffic change based on the target delivery strategy; and
step S3.24, determining the exposure change influence based on the advertisement delivery factor.

8. The system for analyzing the sale volume of the e-commerce commodity according to claim 6, wherein:
the preset marketing data further comprises category sale volume data of a preset category and sale volume data of the competitive commodity of the preset category, wherein the e-commerce commodity belongs to the preset category;
in response to that the data analysis module is configured to perform step S3.11, and step S3.1 further comprises:
step S3.13, comparing the category sale volume data, the sale volume data of the competitive commodity with the sale volume of the e-commerce commodity in terms of a change degree and a change trend to obtain a first comparison result; and
step S3.14, determining the competitive commodity influence corresponding to the e-commerce commodity according to the first comparison result.

9. The system for analyzing the sale volume of the e-commerce commodity according to claim 7, wherein:
the preset marketing data further comprises category sale volume data of a preset category and sale volume data of the competitive commodity of the preset category, wherein the e-commerce commodity belongs to the preset category;
in response to that the data analysis module is configured to perform step S3.23, and step S3.23 comprises:
step S3.231, obtaining each advertisement sale volume contribution rate corresponding to an exposure link, a click link and a conversion link of the target delivery strategy;
step S3.232, determining an advertisement delivery factor causing an exposure change of the e-commerce commodity according to the advertisement sale volume contribution rate;
in response to that the data analysis module is configured to perform step S3.24, and step S3.24 comprises:
step S3.241, comparing a page display element of the e-commerce commodity with a preset display standard to obtain a second comparison result;
step S3.242, determining natural traffic change influence based on the second comparison result; and
step S3.243, determining the exposure change influence based on the advertisement delivery factor and the natural traffic change influence.

10. The system for analyzing the sale volume of the e-commerce commodity according to claim 9, wherein step S3.242 comprises:
step S3.2421, comparing the page display element of the competitive commodity with the preset display standard to obtain a third comparison result; and
step S3.2422, determining the natural traffic change influence based on the second comparison result and the third comparison result.

11. The system for analyzing the sale volume of the e-commerce commodity according to claim 5, wherein step S3.3 comprises:
step S3.31, comparing a price trend of the e-commerce commodity with a price trend of the competitive commodity to obtain a fourth comparison result; and
step S3.32, determining the price change influence based on the fourth comparison result.

12. The system for analyzing the sale volume of the e-commerce commodity according to claim 5, wherein the step of analyzing the sale volume change further comprises:
step S5.1, sorting and displaying the target factor according to each priority of the market demand change influence, the exposure change influence, and the price change influence; and
step S5.2, generating a corresponding operation suggestion based on a sorting and displaying result of the target factor.
